(19) United States
(12) Patent Application Publication
(10) Pub. No.: US 2025/0141199 A1
(43) Pub. Date: May 1, 2025

(54) Excess Cable Organizer

(71) Applicant: HellermannTyton Corporation, Milwaukee, WI (US)

(72) Inventors: Mark W. Cors, St Francis, WI (US); Cabren Spangler, Menomonee Falls, WI (US); Scott G. Klos, Grafton, WI (US); Michael Toll, Whitefish Bay, WI (US)

(73) Assignee: HellermannTyton Corporation, Milwaukee, WI (US)

(21) Appl. No.: 18/916,229

(22) Filed: Oct. 15, 2024

Related U.S. Application Data
(60) Provisional application No. 63/593,448, filed on Oct. 26, 2023.

(51) Int. Cl. H02G 3/08; F16L 3/08

(52) U.S. Cl. CPC H02G 3/081; F16L 3/08

(57) ABSTRACT

Disclosed are techniques and apparatuses for excess cable organization. In one aspect, an excess cable organizer apparatus includes a base portion that is configured to attach to a support surface, at least two first retainer posts that extend from the base portion, and at least one second retainer post that extends from the base portion. The base portion defines a base plane. The first retainer posts extend from the base portion a first distance from the base plane. The first retainer posts define at least one passageway configured to receive a first elongated article therebetween. The second retainer post extends from the base portion a second distance from the base plane and is configured to support a second elongated article.

CROSS-REFERENCE TO RELATED APPLICATION(S)

This application claims the benefit of U.S. Provisional Patent Application Ser. No. 63/593,448, filed on Oct. 26, 2023, the disclosure of which is incorporated by reference herein in its entirety.

### BACKGROUND

Technicians, in industrial, commercial, and other settings, regularly route cables (e.g., wiring, other elongated articles) from a first location to a second location. For example, a technician may utilize a cable longer than necessary to attach a first component to a second component.

Excess lengths of cabling can present many challenges. For example, excess cabling can make it harder to identify which cable is associated with which part of the machinery, leading to longer repair and/or maintenance times and other operational inefficiencies. Excess lengths of cabling can also increase the chances that the cable will get damaged. In such a situation, the technician may coil or neatly store the excess cable in the form of a service loop. A service loop reduces the length of the cable while allowing for future maintenance, adjustments, or reconfiguration without the need for splicing or replacing the cable. A service loop may provide extra slack that allows the cable to be reconnected, rerouted, or repaired without stretching or damaging existing wiring. A service loop can also allow for easier access to the cabling during repairs or upgrades. A technician should responsibly manage (e.g., coil and secure) the service loop to avoid clutter, signal interference, or mechanical stress. For example, a service loop with tight coiling can cause cable strain for certain types of cables (e.g., data cables, optic cables), which can lead to performance loss (e.g., decreased signal transmission).

### SUMMARY

Described herein and illustrated herewith are aspects of techniques and apparatuses for excess cable organization (e.g., an excess cable organizer). The disclosed excess cable organizers are configured to receive, secure, and/or support one or more elongated articles (e.g., cables) relative to a support surface of a workpiece. As used herein, the term “elongated article” is used generally to refer to one or more elongated objects (e.g., wires, hoses, tubes, cables, conduit, and the like) and bundles thereof. For convenience, the terms “elongated article” and “cable” are interchangeably used herein. The support surface may include a surface of a workpiece to which the excess cable organizer apparatus can attach. The support surface may include a mount surface and/or a mount aperture defined therein (e.g., a slot, a channel, a bore, a threaded hole) and the like. Examples of workpieces include machines, cabinets, housings, frames, enclosures, vehicle chassis, panels, rails, support beams, cable routing channels, conveyor channel assemblies, and the like.

In some aspects, the techniques and apparatuses described herein relate to an apparatus that includes a base portion configured to attach to a support surface. The base portion defines a base plane. The apparatus includes at least two first retainer posts that extend from the base portion a first distance from the base plane. The first retainer posts define at least one passageway configured to receive an elongated article (e.g., a first elongated article, a second elongated article, a third elongated article) therebetween. The apparatus includes at least one second retainer post that extends from the base portion a second distance from the base plane. The second distance may be greater than the first distance. The second retainer post is configured to support an elongated article (e.g., first elongated article, second elongated article, third elongated article).

In implementations, the apparatus is an excess cable organizer that is configured to store, in the form of a service loop (e.g., coil), an excess portion of at least one cable that is routed between a first component and a second component. In a first example, the first retainer posts of the excess cable organizer can store an excess portion of a first cable and/or the second retainer posts can store an excess portion of a second cable. In a second example, the first retainer posts of the excess cable organizer can store an excess portion of a first, second, and/or third elongated articles and/or the second retainer posts can store an excess portion of the first, second, and/or third elongated articles. In aspects, the first retainer posts and/or the second retainer posts can store an excess portion(s) of the same cable. In some aspects, the first retainer posts are spaced apart from the second retainer posts.

In aspects, the base portion defines a base plane and the excess cable organizer apparatus includes at least two first retainer posts. A first retainer post may extend from the base portion a first distance from the base plane. In this way, a first retainer post has a length. The length of multiple first retainer posts may be the same length or different lengths. The first retainer posts may extend from the base portion orthogonally to the base plane or at another angle.

The first retainer posts are spaced apart and define at least one passageway therebetween. The passageway is configured to receive an elongated article (e.g., a first elongated article, a second elongated article, a third elongated article) therein, between at least one pair of first retainer posts. An array (e.g., cable management grid) of retainer posts may define an elongated passageway that is configured to receive the an elongated article. The elongated article may be routed along one or more elongated passageways through use of foldback loops to create a service loop.

In some aspects, at least one retainer post of the first retainer posts includes a stem that terminates in a cap (e.g., a head portion). The cap may have a width that is greater than a width of the stem of the first retainer post. In this way, an elongated article (e.g., the first elongated article) may be retained within the passageway, with the cap limiting movement of the elongated article out of the passageway, thereby providing for secure storage of excess cable, as well as support for cable routes. In aspects, a cap may be mushroom-shaped, torus-shaped, rounded, and the like. The caps and/or stems of a first retainer post may be formed as separate components from the base portion. The first retainer posts may be formed with the base portion. The first retainer posts may be formed separately from the base portion and secured to the base portion via at least one retaining feature that is configured to snap into, twist and turn into, slide into, or otherwise connect to the base portion.

The excess cable organizer apparatus includes at least one second retainer post that extends from the base portion a second distance from the base plane. The second distance may be greater than the first distance. The second retainer post is configured to support at least one second elongated article. The second retainer post may be configured to attach to the second elongated article, for example, via a strap (e.g., a cable tie, strapping material, a hook-and-loop fastening strap, a plastic band, a metal band, string, twine, a wire, and the like). The strap may be utilized to bind (e.g., compressively bind) elongated articles that are wrapped around a perimeter of the excess cable organizer into a bundle. In some aspects, the second retainer post extends from at least one of a periphery of the base portion and/or a face portion of the base portion.

In some aspects, the apparatus further includes at least one third retainer post that extends from the base portion. The third retainer post is configured to support at least one of the first, second, and/or elongated articles. The third retainer post may extend from the base portion a third distance from the base plane. The third distance may be greater than the first distance and/or the second distance. The third distance may be equal to the second distance. The third retainer post may be configured to attach to an elongated article (e.g., the second elongated article, the third elongated article), for example, via a strap. The second retainer post(s) and/or the third retainer post(s) may define a tower-like structure (e.g., a cable tie tower), around which the elongated article(s) can be wound. The shape of the outside face(s) of the tower(s) may be configured to operate as hooks that guide and hold cabling in place as the elongated article(s) are wrapped around the perimeter of the excess cable organizer.

In some aspects, the apparatus may further include at least one third retainer post that extends from the base portion. The second retainer post and the third retainer post may be located on opposite sides of the base portion. In some aspects, the second retainer post and the third retainer post are configured to support the second elongated article when the second elongated article is wound around (e.g., wrapped) the second retainer post and the third retainer post. In this way, perimeter loops may be formed that create a service loop.

In some aspects, the second retainer post further includes an arm portion that extends from the base portion and a projection portion that extends from the arm portion. The arm portion is configured to receive the second elongated article, and the projection portion is configured to reduce an occurrence of the second elongated article sliding off the arm portion.

In some aspects, the second retainer post further includes an arm portion that extends from the base portion and a projection portion that extends from the arm portion. The arm portion defines a cradle portion configured to receive the second elongated article, and the projection portion is configured to reduce an occurrence of the second elongated article moving out of the cradle portion.

In some aspects, the apparatus further includes at least one third retainer post that extends from the base portion. The first retainer post further includes a first arm portion that extends from the base portion and a first projection portion that extends from the first arm portion. The first arm portion defines a first cradle portion configured to receive the second elongated article. The first projection portion is configured to prevent the second elongated article from moving out of the first cradle portion. The second retainer post further includes a second arm portion that extends from the base portion and a second projection portion that extends from the second arm portion. The second arm portion defines a second cradle portion configured to receive the second elongated article. The second projection portion is configured to prevent the second elongated article from moving out of the second cradle portion. The second retainer post and the third retainer post may be located on opposite sides of the base portion. The first cradle portion and the second cradle portion may face away from a center of the base portion.

In some aspects, the first retainer posts can be configured to receive one or more portions of an elongated article after the elongated article is wrapped in a loop around and/or attached to the second and/or third elongated posts. In this way, the first retainer posts may maintain tension on the loop and help to keep in a coiled configuration.

In some aspects, a retainer post defines a saddle portion that is configured to receive a strap to bind the elongated article to the retainer post. The saddle portion may define a saddle (e.g., channel, chamfer, bevel, groove, notch) that is configured to receive the elongated article(s). The strap (e.g., cable tie) may be used to attach the elongated article to the apparatus (e.g., to the retainer post), with the elongated article held in the saddle. The saddle portion may define a strap aperture therethrough that is configured to receive the strap, which can be passed through the strap aperture, wrapped around the elongated article, and tightened to attach the elongated article to the retainer portion at the saddle portion. The geometry of the strap aperture may allow for easy insertion of a strap to secure elongated articles wrapped around the excess cable organizer. The strap may encircle the bundle and may be received by the strap aperture, which thereby attaches the bundle to the retainer post. The strap aperture may guide the strap. In some aspects, a strap may be utilized to bind elongated articles that are not wrapped around a perimeter of the excess cable organizer (e.g., wrapped around the second and third retainer posts) to the saddle portion.

In some aspects, the saddle portion includes a block that is configured to attach to the second elongated article via the strap. The block defines a strap aperture therethrough. The strap aperture is configured to receive the strap therein. The strap may be passed through the strap aperture (e.g., a slot) to form a loop. The strap aperture may be configured to receive the strap, which is utilized to connect the elongated article(s) with the arm portion. The strap aperture may be configured to receive an end of the strap (e.g., a tail of a cable tie), which is passed through the arm portion to orient the strap in a position where a technician can form a loop of the strap. The strap aperture may include an inner opening opposite an outer opening, with a passageway that extends therebetween.

The block may include a top portion that has a mounting surface that forms a saddle that is configured to support the elongated article(s). The strap aperture may be defined relative to the top portion. The strap may be extended through the strap aperture and around the top portion to cinch the elongated article to the block at the top portion. The strap aperture may be configured to receive an end of the strap (e.g., a tail of the strap) and guide it through the arm to orient the strap in a position where the technician can create a bundle from one or more elongated articles held in the cradle and/or attach the elongated article(s) to the apparatus. In such a configuration, the technician can insert an end of a strap (e.g., a tail end) into the strap aperture to pass the strap to a position where the technician can then grasp the end of the strap, loop the strap over and/or around the elongated article(s), and connect the ends of the strap together to bundle the elongated article(s) in the cradle and to the block of the retainer post.

In some aspects, the second retainer post defines a saddle portion. The saddle portion is configured to receive a strap to bind the second elongated article to the second retainer post. The saddle portion may further include a strap aperture configured to receive the strap. The strap aperture may be defined through the second retainer post and shaped to guide the strap around the second elongated article.

Elongated article routings in channels or raceways and on routing surfaces can be highly congested, with multiple elongated articles attached to each other that create large, interwoven bundles (e.g., bundles of wiring). These bundles can block the routing paths of additional elongated articles and make it difficult to service and update systems. As a result of this congestion, elongated articles may be damaged when a technician cuts a strap (e.g., cable tie) off interwoven bundles as they build and re-work wiring paths. In some aspects, the saddle portion further includes a pair of flanges that define a receiver therebetween. The receiver may be configured to receive a cutter tool for cutting the strap. The pair of flanges may be spaced apart and the receiver may be positioned between the pair of flanges. The receiver may define the saddle of the saddle portion. The receiver may be configured to locate (e.g., position, hold) the elongated article in a routed position. The receiver may include a shape configured to receive the elongated article (e.g., a curved shape, a U-shape, and the like).

Because the elongated article(s) may be tightly bound (e.g., compressively) with a strap on a receiver, if the attached elongated article(s) need to be reworked (e.g., to add and/or remove one or more elongated articles), it can be difficult for a technician to cut off the strap without causing damage (e.g., nicking) to one or more of the elongated articles. As a result, a receiver may be configured as a cut zone. The receiver may define a cut guide that is configured to be bridged (e.g., spanned) by the strap. The cut guide may be configured to guide a technician when the technician acts to cut the strap through use of a cutter tool (e.g., a diagonal plier tool, wire cutters, side cutters, a bladed cutter, a knife, and the like) to free the elongated article(s) attached to the apparatus (e.g., held in a receiver of the apparatus). The cut guide may define a location for the technician to position the cutting surface(s) of the cutter tool when cutting the strap. In this way, damage to the elongated article caused when the strap is removed by cutting during a rework process is prevented.

In some aspects, the apparatus further includes a cover portion. The cover portion may be configured to cover at least one of the first retainer posts and/or at least one of the second retainer posts. In this way, a cover may hide a service loop and protect it. In some aspects, the cover portion is further configured to cover the first retainer post and the second retainer post. In some aspects, the cover portion is further configured to cover the first retainer post, the second retainer post, and the third retainer post. A cover may also provide a surface onto which a company logo or other indicia are displayed. In other aspects, the cover portion is optional.

In some aspects, the apparatus further includes a cover support pillar that extends from at least one of the base portion or an underside of the cover portion. The cover support pillar may space the cover portion apart from the first and second retainer posts. The cover support pillar may be configured to support the cover portion (e.g., the underside of the cover portion). In some aspects, the cover support pillar has a length longer than a length of the first, second, and/or third retainer posts.

In some aspects, the apparatus includes a lock mechanism configured to lock the cover onto the apparatus in a position that covers one or more of the retainer posts. The lock mechanism may include a snap-fit joint where a first component part feature (e.g., a protrusion, hook, knob, bulge) is configured to latch (e.g., latching engagement) with a reciprocal or corresponding second component part feature (e.g., detent, depression (undercut), groove, opening). Examples of snap-fit joints include, but are not limited to, cantilever snap-fit connections, annular snap-fit connections, torsional snap-fit connections, and the like.

In some aspects, the base portion includes a center segment that is frangibly attached to a side segment at a breakable portion and the breakable portion connects the base portion to the center segment. Unless context dictates otherwise, use herein of the phrase “frangibly attached” refers to an attachment that may be broken by a technician during use at a defined snap point under a predetermined loading condition. The breakable portion is configured to break at a defined snap point along which the breakable portion is configured to break under a predetermined loading condition. The center segment may include the first retainer post and the second retainer post. The apparatus may further include at least one third retainer post that extends from the side segment.

The side segment may include second and/or third retainer posts. The center segment and the side segment may be connected at a breakable portion. To express it another way, the center segment and the side segment may be joined at the breakable portion. The breakable portion is configured to enable the excess cable organizer to be separated (e.g., broken) into the center segment and at least one side segment. Such a segmented structure may allow the excess cable organizer to be broken apart and used in multiple locations.

The breakable portion is configured to break at a defined zone of weakness under a predetermined loading condition (e.g., a connection-breaking force). The defined zone of weakness may be a line, zone, area, point, region, path, and the like. The defined zone of weakness may be intentionally incorporated during the manufacture of the material of the excess cable organizer and/or through subsequent modification of the material of the excess cable organizer. The defined zone of weakness (e.g., a snap point) can be achieved through various techniques, such as the provision of one or more of a notch, a groove, a score line, consecutive holes, a perforation, variations in material thickness, a void, and/or other weakening features known in the art that would facilitate the breaking of an organizer along a predetermined path. The breakable portion may be formed of a polymeric material. The center segment and/or the side segment may be formed of the same or a different polymeric material. The polymeric material itself may exhibit some level of elasticity, but the defined line of weakness significantly reduces its resistance to breakage at that specific location.

The center segment may be separated from the side segment by breaking the excess cable organizer at the breakable portion. The breakable portion may include a defined snap point (e.g., a fracture plane), along which the breakable portion is configured to break under a predetermined loading condition. The snap point may be defined between the center segment and the side segment. The defined zone of weakness (e.g., snap point) may include at least one notch defined in the excess cable organizer at the snap point. One or more notches may be defined in the excess cable organizer at the snap point. A technician may break the breakable portion at the line of the snap point, for example, by application of a force (e.g., a bending force, a snapping force, a twisting force) with one or more of the hands of the technician, by using a tool to apply a prying action, by striking the excess cable organizer at the breakable portion with an object, by striking the excess cable organizer on a surface at the breakable portion, and the like.

In aspects, the breakable portion may not be broken at the line of the snap point and the excess cable organizer may be utilized with the center segment and the side segment(s) connected together in their connected state. In other aspects, the breakable portion is broken at the line of the snap point and the center segment and the side segment(s) of the excess cable organizer are disconnected from one another and used in their separated state. In their separated state, the center segment and the side segment(s) may be positioned separately from one another. In some aspects, in the separated state, one of the center segment or the side segment may not be utilized.

In some aspects, the base portion further includes a connector portion configured to attach the base portion to the support surface. The connector portion may include at least one of an adhesive fastener or an aperture defined in the base portion that is configured to receive a mechanical fastener (e.g., a screw, a bolt). A connector portion may include any common connection manner, including, but not limited to, a fastener (e.g., a blind hole fastener, a clamp fastener, a mechanical fastener (e.g., a screw mount), a T-nut fastener for a T-slot metal frame, an arrowhead fastener, a fir-tree fastener, a mounting edge clip, a twist-lock fastener configured for receipt into a slot of a rail, a weld stud mount, a cable attachment, a hose attachment), an adhesive fastener (e.g., double-sided adhesive tape), a magnet, a friction fit, and the like, and combinations thereof (e.g., a fastener and an adhesive fastener, an adhesive fastener and a magnet). In implementations, a connector portion may cooperate with an aperture (e.g., mounting hole) that is defined through the anchor point. The aperture may be configured to receive a fastener (e.g., a bolt, a screw) that engages a mounting aperture (e.g., a bore) that is defined in the workpiece. In other implementations, a connector may be configured to engage an elongated fastener (e.g., a stud, a threaded bolt) that extends from the workpiece, may be configured to clamp onto an edge of the workpiece (e.g., utilizing an edge clip), and/or the like.

In aspects, the techniques and apparatuses for excess cable organization include routing indicia configured to guide a technician to utilize a minimum bend radius when routing elongated articles between passageways in a cable organizer. For example, the routing indicia may be configured to guide the technician to use an appropriate bend radius for foldback loop routing (e.g., suggesting a minimum 1-inch bend radius).

In aspects, the techniques and apparatuses for excess cable organization include systems (e.g., a system that includes an excess cable organizer apparatus and a cover).

One or more of the components (e.g., base portion, first retainer posts, second retainer posts, third retainer posts, cover, breakable portion) of the techniques and apparatuses for excess cable organization may be integrally formed of a suitable material(s) through one or more of an injection-molding process, an additive manufacturing process (e.g., a fused deposition modeling (FDM) process, a fused deposition modeling (FDM) process, a three-dimensional (3D) printing process), or another suitable process.

The components of the techniques and apparatuses for excess cable organization may be fabricated of any suitable material, including, but not limited to, metals, ceramics, polymers (e.g., polymeric material), and composites. For example, components of an excess cable organizer may be fabricated of one or more suitably resilient materials, including polymeric materials. A suitable polymeric material may include one or more of a frangible polymeric material, a notch-sensitive polymeric material, polycarbonate, polyamide, polyamide 6.6, nylon 6, nylon, polypropylene, polyphenylene sulfide (PPS), polystyrene, polyether ether ketone, polyaryletherketone, polyacetal, polybutylene terephthalate, acrylonitrile butadiene styrene (ABS), ABS with additional butadiene content, ABS 3D printing filament used in a fused deposition modeling (FDM) printer, ABS 3D printing filament used in a fused filament fabrication (FFF) printer, styrene butadiene rubber (SBR), SBR with additional rubber content, a stiff polymer resin blended with an elastomer, and the like, and/or copolymers. The polymeric material may include blends of one or more of the aforementioned materials to achieve synergies of individual material properties, the term “synergies” referring to the interaction and/or cooperation of two or more polymers to produce a combined effect greater than the sum of their separate polymer properties.

This Summary is provided to introduce simplified concepts of techniques and apparatuses for excess cable organization, which are further described below in the Detailed Description and are illustrated in the Drawings. This Summary is not intended to identify essential features of the claimed subject matter, nor is it intended for use in determining the scope of the claimed subject matter.

### BRIEF DESCRIPTION OF THE DRAWINGS

The details of one or more implementations of techniques and apparatuses for excess cable organization are described with reference to the following Drawings.

FIG. 1A is an exploded perspective view of a first embodiment of an excess cable organization system, which includes an excess cable organizer.

FIG. 1B is an assembled perspective view of the excess cable organization system of FIG. 1A.

FIG. 1C is a cross-sectional view along lines 1C-1C in FIG. 1B.

FIG. 1D is a plan view of the excess cable organizer of the excess cable organization system of FIG. 1A.

FIG. 1E is a side view of the excess cable organizer of FIG. 1D.

FIG. 2A is an exploded perspective view of a second embodiment of an excess cable organization system, which includes an excess cable organizer.

FIG. 2B is an assembled perspective view of the excess cable organization system of FIG. 2A.

FIG. 2C is a cross-sectional view along lines 2C-2C in FIG. 2B.

FIG. 3 is a plan view of a third embodiment of an excess cable organizer.

FIG. 4A is a side view of a fourth embodiment of an excess cable organizer.

FIG. 4B is a plan view of the excess cable organizer of FIG. 4A.

### DETAILED DESCRIPTION

The Summary provided above describes aspects of techniques and apparatuses for excess cable organization. These aspects are further described in following Detailed Description of example implementations and embodiments. Before explaining the example implementations and embodiments of techniques and apparatuses for excess cable organization in detail, it is to be understood that the techniques and apparatuses for excess cable organization are not limited in their applications to the details of the particular arrangements described and illustrated since the disclosed techniques and apparatuses for excess cable organization are capable of other embodiments. Also, the terminology used herein is for the purpose of description and not of limitation.

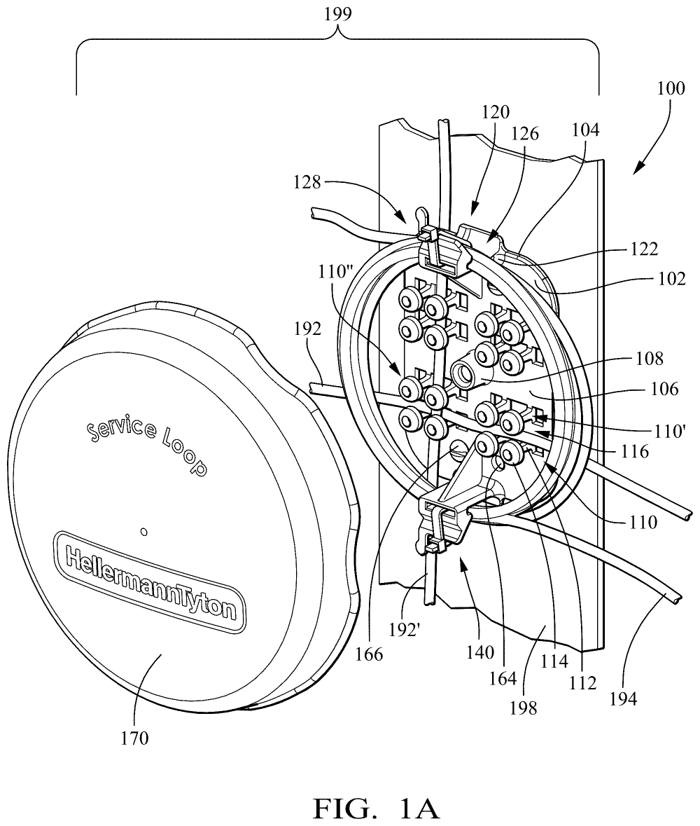

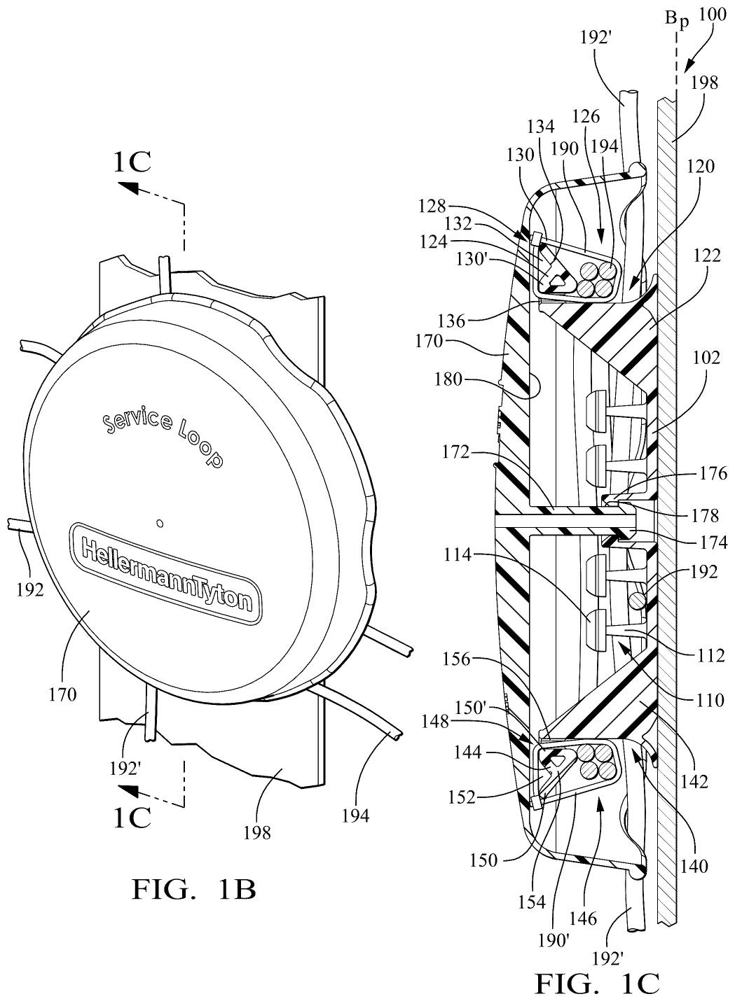

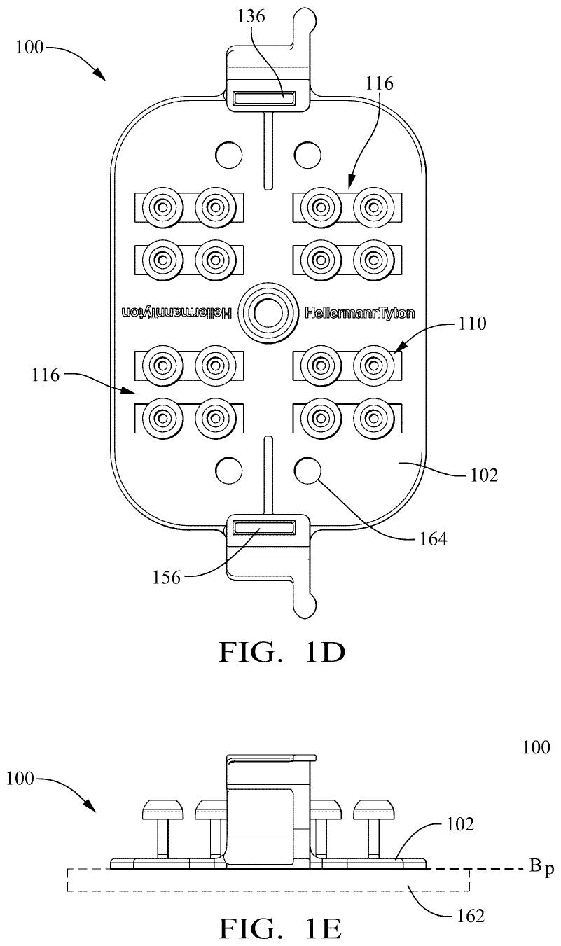

The following Detailed Description of example implementations of techniques and apparatuses for excess cable organization refers to the accompanying drawing figures. The same reference numbers in different drawing figures may identify the same or similar features, elements, and/or components. In this detailed description, the first digit(s) of a call-out number may correlate with the first figure number in which the call-out number is labeled. For example, call-out numbers that start with a 1 (e.g., base portion 102, retainer post 110) may represent details first called out with respect to FIGS. 1A-1E.

Referring to FIGS. 1A, 1B, 1C, 1D, and 1E, a first embodiment of an excess cable organizer apparatus (e.g., organizer 100) is illustrated. The organizer 100 includes a base portion 102 that is configured to attach to a support surface 198, for example, via a connector portion 160, which is discussed below. The base portion 102 includes a plurality of first retainer posts (110, 110′, 110″) that extend therefrom. In the aspect illustrated in FIGS. 1A-1E, the first retainer posts 110 extend orthogonally from the base portion 102 and form a gridded holding structure. The base portion 102 defines a base plane (Bp), which is illustrated in FIG. 1E. The first retainer posts (110, 110′, 110″) extend from the base portion 102 a first distance from the base plane.

The first retainer posts (110, 110′, 110″) define at least one passageway (e.g., passageway 116) that is configured to receive an elongated article (e.g., a first elongated article (192, 192′)) therebetween. The first retainer post 110 includes a stem 112 that terminates in a cap 114. The cap 114 has a width that is greater than a width of the stem 112.

The organizer 100 further includes at least one second retainer post 120 that extends from the base portion 102 a second distance from the base plane. The second distance may be greater than the first distance. The first retainer posts (110, 110′, 110″) are spaced apart from the second retainer post 120. The second retainer post 120 is configured to support a second elongated article 194. The second elongated article 194 is illustrated as wound around the second retainer post 120 to organize and route the second elongated article 194. The second retainer post 120 extends from at least one of a periphery 104 of the base portion 102. In other aspects, the second retainer post 120 extends from a face portion 106 of the base portion 102.

The organizer 100 includes at least one third retainer post 140 that extends from the base portion 102. The third retainer post 140 is configured to support at least one of the second elongated article 194 or a third elongated article (not illustrated). For example, the second retainer post 120 may support the second elongated article 194 and the third retainer post 140 may support a third elongated article. In FIGS. 1A-1E, the second elongated article 194 is wound around the second retainer post 120 and the third retainer post 140. In this way, the second retainer post 120 and the third retainer post 140 are configured to support the second elongated article 194 when the second elongated article 194 is wound around the second retainer post 120 and the third retainer post 140.

The second retainer post 120 includes an arm portion 122 that extends from the base portion 102 and a projection portion 124 that extends from the arm portion 122. The arm portion 122 is configured to receive the second elongated article 194 and the projection portion 124 is configured to reduce an occurrence of the second elongated article 194 sliding off the arm portion 122. The arm portion 122 may define a cradle portion 126 that is configured to receive the second elongated article 194, and the projection portion 124 may be configured to reduce an occurrence of the second elongated article 194 moving out of the cradle portion 126. The third retainer post 140 includes a second arm portion 142 that extends from the base portion 102 and a second projection portion 144 that extends from the second arm portion 142. The second arm portion 142 is configured to receive the second elongated article 194 and the second projection portion 144 is configured to reduce an occurrence of the second elongated article 194 sliding off the second arm portion 142. The second arm portion 142 may define a second cradle portion 146 that is configured to receive the second elongated article 194, and the projection portion 124 may be configured to reduce an occurrence of the second elongated article 194 moving out of the cradle portion 146. In the aspect of FIGS. 1A-1E, the second retainer post 120 and the third retainer post 140 are located on opposite sides of the base portion 102. In this way, the first cradle portion 126 and the second cradle portion 146 face away from a center 108 of the base portion 102.

The second retainer post 120 defines a saddle portion 128 that is configured to receive a strap 190 to bind the second elongated article 194 to the second retainer post 120, as illustrated in FIGS. 1A and 1C. The third retainer post 140 defines a saddle portion 148 that is configured to receive a strap 190′ to bind the second elongated article 194 to the third retainer post 140, as illustrated in FIGS. 1A and 1C. The second retainer post 120 includes a pair of flanges (130, 130′) that define a receiver 132 therebetween. The receiver 132 is configured to receive a cutter tool (not illustrated) for cutting the strap 190. The third retainer post 140 includes a pair of flanges (150, 150′) that define a receiver 152 therebetween. The receiver 152 is also configured to receive the cutter tool (not illustrated) for cutting the strap 190′.

The saddle portion 128 of the second retainer post 120 includes a block 134 that is configured to attach to the second elongated article 194 via the strap 190. The block 134 defines a strap aperture 136 therethrough, which is configured to receive the strap 190 therein to bind the second elongated article 194 to the second retainer post 120. The strap aperture 136 is defined through the second retainer post 120 and shaped to guide the strap 190 around the second elongated article 194. The saddle portion 148 of the third retainer post 140 includes a block 154 that is configured to attach to the second elongated article 194 via the strap 190′. The block 154 of the saddle portion 128 defines a strap aperture 156 therethrough, which is configured to receive the strap 190′ therein to bind the second elongated article 194 to the third retainer post 140. The strap aperture 156 is defined through the third retainer post 140 and shaped to guide the strap 190 around the second elongated article 194.

The organizer 100 illustrated in FIGS. 1A-1E includes a cover portion 170 that is configured to cover the first retainer post 110, the second retainer post 120, and the third retainer post 140. Collectively, the organizer 100, cover portion 170, and support surface 198 may define a system 199. The cover portion 170 includes a cover support pillar 172 that extends from an underside 180 of the cover portion 170. The cover support pillar 172 spaces the cover portion 170 apart from the first retainer posts 110, the second retainer posts 120, and/or the third retainer posts 140. The cover support pillar 172 is configured to support the underside 180 of the cover portion 170.

The organizer 100 includes a lock mechanism that is configured to lock the cover portion 170 onto the organizer 100 in a position that covers one or more of the retainer posts (e.g., first retainer post 110, second retainer post 120, third retainer post 140). In FIGS. 1A-1E, the lock mechanism includes a snap-fit joint that is configured for annular snap-fit connection. In such a snap-fit joint, a first component part feature (e.g., a protrusion, hook, knob, bulge) is configured to latch (e.g., latching engagement) with a reciprocal or corresponding second component part feature (e.g., detent, depression (undercut), groove, opening). In the aspect of FIGS. 1A-1E, the cover support pillar 172 includes a knob 174 that is configured to latch with a connecting ledge 178 (e.g., detent) defined within a boss 176 that extends from the base portion 102 to form the annular snap-fit connection. The knob 174 is configured to flexibly insert through an aperture defined in the boss 176 to enable the knob 174 to snap-fit engage with the connecting ledge 178 to retain the cover portion 170 on the base portion 102.

The base portion 102 includes a connector portion that is configured to attach the base portion 102 to the support surface 198. In FIGS. 1A and 1D, the connector portion is illustrated as an aperture 164 defined in the base portion 102 that is configured to receive a mechanical fastener 166. In FIG. 1E, the connector portion is illustrated as an adhesive fastener 162 (e.g., double-sided adhesive tape) that is applied to a back side of the base portion 102.

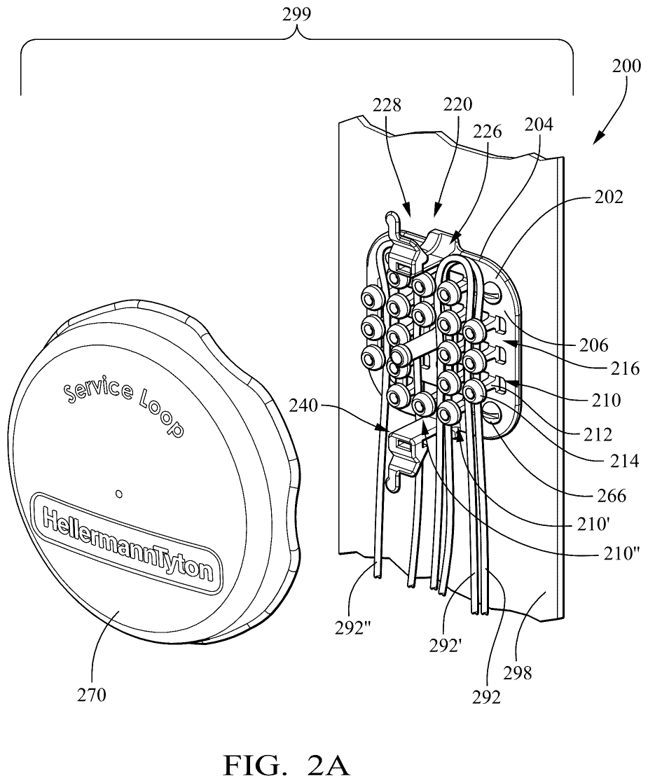

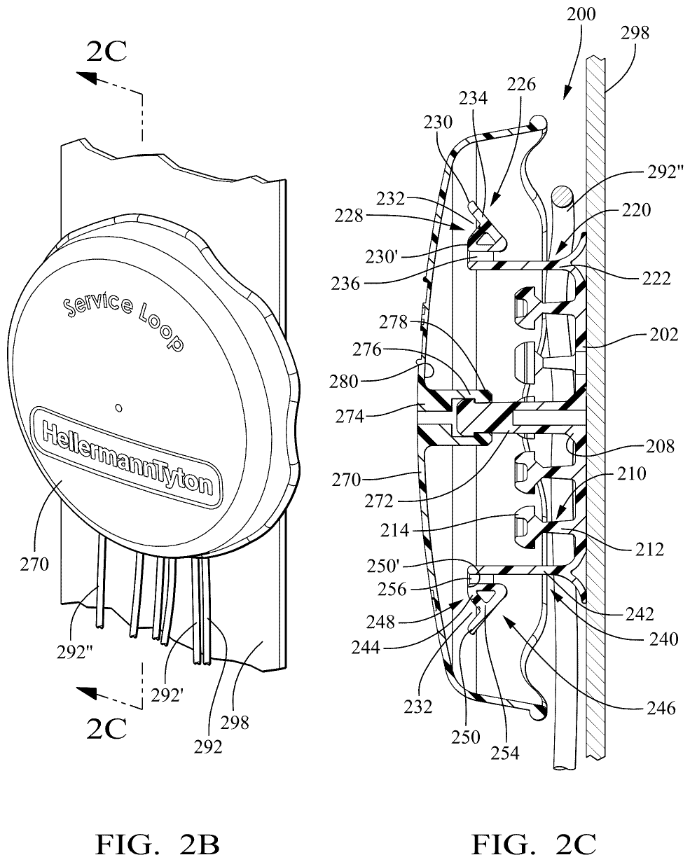

Referring to FIGS. 2A-2C, a second embodiment of an excess cable organizer apparatus (e.g., organizer 200) is illustrated. The organizer 200 is similar to the organizer 100 illustrated in FIGS. 1A-1E and described above, except as detailed below. Thus, the organizer 200 includes a base portion 202, a periphery 204, a face portion 206, a center 208, a first retainer post (210, 210′, 210″), a stem 212, a cap 214, a passageway 216, a second retainer post 220, an arm portion 222, a projection portion 224, a cradle portion 226, a saddle portion 228, flanges 230, a receiver 232, a block 234, a strap aperture 236, a third retainer post 240, a second arm portion 242, a second projection portion 244, a second cradle portion 246, a saddle portion 248, flanges 250, a receiver 252, a block 254, a strap aperture 256, a connector portion 260, an adhesive fastener 262, an aperture 264, a mechanical fastener 266, a cover portion 270, a cover support pillar 272, a knob 274, a boss 276, a connecting ledge 278, an underside 280, a strap 290, an elongated article (292, 292′, 292″), a support surface 298, and a system 299.

The organizer 200 illustrated in FIGS. 2A-2C includes a cover portion 270 that is configured to cover a first retainer post 210, a second retainer post 220, and a third retainer post 240. The organizer 200 includes a lock mechanism that is configured to lock the cover portion 270 onto the organizer 200 in a position that covers one or more of the retainer posts (e.g., first retainer post 210, second retainer post 220, third retainer post 240). The cover portion 270 includes a cover support pillar 272 that extends from a base portion 202. The cover support pillar 272 spaces the cover portion 270 apart from the first retainer post 210, the second retainer post 220, and/or the third retainer post 240. The cover support pillar 272 is configured to support an underside 280 of the cover portion 270. The lock mechanism includes a snap-fit joint that is configured for annular snap-fit connection. In such a snap-fit joint, a first component part feature (e.g., a protrusion, hook, knob, bulge) is configured to latch with a reciprocal or corresponding second component part feature (e.g., detent, depression (undercut), groove, opening). In the aspect of FIGS. 2A-2C, the cover support pillar 272 includes a knob 274 that is configured to latch with a connecting ledge 278 (e.g., detent) defined within a boss 276 that extends from the cover portion 270 to form the annular snap-fit connection. The knob 274 is configured to flexibly insert through an aperture defined in the boss 276 to enable the knob 274 to snap-fit engage with the connecting ledge 278 to retain the cover portion 270 on the base portion 202.

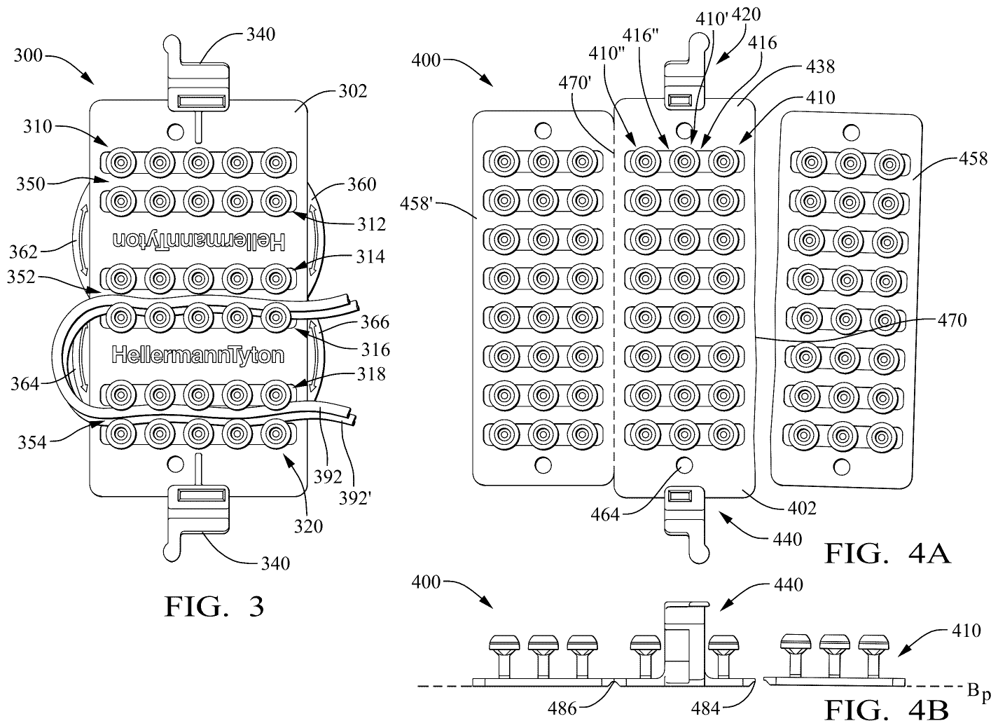

Referring to FIG. 3, a third embodiment of an excess cable organizer apparatus (e.g., organizer 300) is illustrated. The organizer 300 is similar to the organizers (organizer 100, organizer 200) respectively illustrated in FIGS. 1A-1E and FIGS. 2A-2C and described above, except as detailed below. Thus, the organizer 300 includes a base portion 302, first retainer posts (310, 312, 314, 316, 318, 320), passageways (350, 352, 354), a second retainer post 340, a third retainer post 342, and elongated articles (392, 392′).

The organizer 300 illustrated in FIG. 3 includes three pairs of rows of first retainer posts, including a first-row pair 330, a second-row pair 332, and a third-row pair 334, which are spaced apart from one another. Each row pair defines a passageway. Thus, the first-row pair 330 defines the first passageway 350, the second-row pair 332 defines the second passageway 352, and the third-row pair 334 defines the third passageway 354.

The organizer 300 may define routing indicia for guiding a technician to apply a preferred foldback loop routing of the elongated articles (392, 392′). For example, first routing indicia 360 may guide a transition from the first passageway 350 to the second passageway 352 on a first side of the organizer 300, second routing indicia 362 may guide a transition from the first passageway 350 to the second passageway 352 on a second side of the organizer 300, third routing indicia 364 may guide a transition from the second passageway 352 to the third passageway 354 on a second side of the organizer 300, and fourth routing indicia 366 may guide a transition from the second passageway 352 to the third passageway 354 on a first side of the organizer 300. In this way, the technician can be guided to use an appropriate bend radius for the foldback loop routing (e.g., suggesting a minimum 1-inch bend radius). In the aspect illustrated in FIG. 3, the first elongated article 392 is routed from the first passageway 350 to the second passageway 352 to the third passageway 354, and the second elongated article 392′ is routed from the second passageway 352 to the third passageway 354. The routing indicia may be defined on the base portion 302 or another location. In this way, the technician can form a service loop with proper coiling and incidences of cable strain that lead to performance loss (e.g., decreased signal transmission) can be avoided (e.g., for data cables, for optic cables).

Referring to FIGS. 4A and 4B, a fourth embodiment of an excess cable organizer apparatus (e.g., organizer 400) is illustrated. The organizer 400 is similar to the organizers (organizer 100, organizer 200) respectively illustrated in FIGS. 1A-1E and FIGS. 2A-2C and described above, except as detailed below. Thus, the organizer 400 includes a base portion 402, first retainer posts (410, 410′, 410″), passageways (416, 416′), a second retainer post 420, a third retainer post 440, and an aperture 464.

The base portion 402 includes a center segment 438 that is frangibly attached to a side segment (e.g., side segment 458, side segment 458′) at a breakable portion (e.g., breakable portion 470, breakable portion 470′). The breakable portion 470 is configured to break under a predetermined loading condition. The breakable portion 470 is configured to enable the organizer 400 to be separated (e.g., broken) into the center segment 438 and at least one side segment (e.g., side segment 458, side segment 458′). Such a segmented structure may allow the organizer 400 to be broken apart and used by the technician in multiple locations.

Some additional examples of techniques and apparatuses for excess cable organization are as follows:

Example 1. An apparatus comprising: a base portion configured to attach to a support surface, the base portion defining a base plane; at least two first retainer posts that extend from the base portion a first distance from the base plane, the first retainer posts defining at least one passageway configured to receive a first elongated article therebetween; and at least one second retainer post that extends from the base portion a second distance from the base plane, the second retainer post configured to support a second elongated article.

Example 2. The apparatus of Example 1, wherein the second retainer post extends from at least one of a periphery of the base portion or a face portion of the base portion.

Example 3. The apparatus of Example 1, further comprising: at least one third retainer post that extends from the base portion, the third retainer post configured to support at least one of the second elongated article or a third elongated article.

Example 4. The apparatus of Example 3, wherein the second retainer post and the third retainer post are configured to support at least one of the second elongated article when the second elongated article is wound around the second retainer post and the third retainer post or the third elongated article when the third elongated article is wound around the second retainer post and the third retainer post.

Example 5. The apparatus of Example 1, wherein the second retainer post further comprises: an arm portion that extends from the base portion, wherein the arm portion is configured to receive the second elongated article; and a projection portion that extends from the arm portion, the projection portion configured to reduce an occurrence of the second elongated article sliding off the arm portion.

Example 6. The apparatus of Example 1, wherein the second retainer post further comprises: an arm portion that extends from the base portion, wherein the arm portion defines a cradle portion configured to receive the second elongated article; and a projection portion that extends from the arm portion, the projection portion configured to reduce an occurrence of the second elongated article moving out of the cradle portion.

Example 7. The apparatus of Example 1, further comprising at least one third retainer post that extends from the base portion, wherein: the second retainer post further comprises: a first arm portion that extends from the base portion, wherein the first arm portion defines a first cradle portion configured to receive the second elongated article; and a first projection portion that extends from the first arm portion, the first projection portion configured to prevent the second elongated article from moving out of the first cradle portion; and the third retainer post further comprises: a second arm portion that extends from the base portion, wherein the second arm portion defines a second cradle portion configured to receive the second elongated article; and a second projection portion that extends from the second arm portion, the second projection portion configured to prevent the second elongated article from moving out of the second cradle portion, wherein the second retainer post and the third retainer post are located on opposite sides of the base portion, and wherein the first cradle portion and the second cradle portion face away from a center of the base portion.

Example 8. The apparatus of Example 1, wherein the second retainer post defines a saddle portion configured to receive a strap to bind the second elongated article to the second retainer post.

Example 9. The apparatus of Example 8, wherein the second retainer post further comprises a pair of flanges that define a receiver therebetween, the receiver configured to receive a cutter tool for cutting the strap.

Example 10. The apparatus of Example 8, wherein the saddle portion comprises: a block, the block configured to attach to the second elongated article via the strap, the block defining a strap aperture therethrough, the strap aperture configured to receive the strap therein.

Example 11. The apparatus of Example 1, further comprising: a cover portion, the cover portion configured to cover at least one of the first retainer posts or at least one of the second retainer posts.

Example 12. The apparatus of Example 11, wherein the cover portion is further configured to cover the first retainer post and the second retainer post.

Example 13. The apparatus of Example 12, further comprising: a cover support pillar that extends from at least one of the base portion or an underside of the cover portion, the cover support pillar spacing the cover portion apart from the first and second retainer posts, the cover support pillar configured to support the underside of the cover portion.

Example 14. The apparatus of Example 1, further comprising: at least one third retainer post that extends from the base portion, wherein the second retainer post and the third retainer post are located on opposite sides of the base portion.

Example 15. The apparatus of Example 1, wherein at least one retainer post of the first retainer posts includes a stem that terminates in a cap having a width that is greater than a width of the stem.

Example 16. The apparatus of Example 1, wherein the base portion includes a center segment that is frangibly attached to a side segment at a breakable portion, the breakable portion connecting the base portion to the center segment, the breakable portion configured to break at a defined snap point along which the breakable portion is configured to break under a predetermined loading condition, wherein the center segment includes the first retainer posts and the second retainer posts, and wherein the apparatus further includes at least one third retainer post that extends from the side segment.

Example 17. The apparatus of Example 1, wherein the base portion further comprises: a connector portion configured to attach the base portion to the support surface, the connector portion comprising at least one of an adhesive fastener or an aperture defined in the base portion that is configured to receive a mechanical fastener.

Example 18. The apparatus of Example 1, wherein the first retainer posts are spaced apart from the second retainer post.

Example 19. The apparatus of Example 1, wherein the first retainer posts define at least two passageways configured to receive a first elongated article therebetween, wherein the apparatus further comprises routing indicia configured to guide a technician to utilize a minimum bend radius when routing the first elongated article between the passageways.

Example 20. The apparatus of Example 1, wherein the second retainer post defines a saddle portion, the saddle portion configured to receive a strap to bind the second elongated article to the second retainer post, the saddle portion further comprising a strap aperture configured to receive the strap, the strap aperture defined through the second retainer post and shaped to guide the strap around the second elongated article.

In this description of aspects of techniques and apparatuses for excess cable organization, ordinal numbers such as “first” and “second” are used only to distinguish between different described objects, and have no limitation on a location, a sequence, a priority, a quantity, content, or the like of the described objects. For example, a “first elongated article” is used as an example, and there may be one or more “elongated articles.” Additionally, objects modified by different ordinal numbers may be the same or different objects. For example, if the described object is an “elongated article,” a “first elongated article” and a “second elongated article” may be the same or different elongated articles. Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying Drawings and terms discussed herein may be indicative of one or more items or terms, and thus reference may be made interchangeably to single or plural forms of the items and terms in this written description.

In the Summary above, in this Detailed Description, and in the accompanying Drawings, reference is made to particular features of the techniques and apparatuses for excess cable organization. It is to be understood that the disclosure of the techniques and apparatuses for excess cable organization in this specification does not include all possible combinations of such particular features. For example, where a particular feature is disclosed in the context of a particular aspect or embodiment, that feature can also be used, to the extent possible, in combination with and/or in the context of other particular aspects and embodiments of techniques and apparatuses for excess cable organization generally. Although implementations of techniques and apparatuses for excess cable organization have been described in language specific to certain features and/or methods, the subject of the appended claims is not necessarily limited to the specific features or methods described. Rather, the specific features and methods are disclosed as example implementations of techniques and apparatuses for excess cable organization.

What is claimed is:

1. An apparatus comprising:
a base portion configured to attach to a support surface, the base portion defining a base plane;
at least two first retainer posts that extend from the base portion a first distance from the base plane, the first retainer posts defining at least one passageway configured to receive a first elongated article therebetween; and
at least one second retainer post that extends from the base portion a second distance from the base plane, the second retainer post configured to support a second elongated article.

2. The apparatus of claim 1, wherein the second retainer post extends from at least one of a periphery of the base portion or a face portion of the base portion.

3. The apparatus of claim 1, further comprising:
at least one third retainer post that extends from the base portion, the third retainer post configured to support at least one of the first elongated article, a second elongated article, or a third elongated article.

4. The apparatus of claim 3, wherein the second retainer post and the third retainer post are configured to support at least one of the second elongated article when the second elongated article is wound around the second retainer post and the third retainer post or the third elongated article when the third elongated article is wound around the second retainer post and the third retainer post.

5. The apparatus of claim 1, wherein the second retainer post further comprises:
an arm portion that extends from the base portion, wherein the arm portion is configured to receive the second elongated article; and
a projection portion that extends from the arm portion, the projection portion configured to reduce an occurrence of the second elongated article sliding off the arm portion.

6. The apparatus of claim 1, wherein the second retainer post further comprises:
an arm portion that extends from the base portion, wherein the arm portion defines a cradle portion configured to receive the second elongated article; and
a projection portion that extends from the arm portion, the projection portion configured to reduce an occurrence of the second elongated article moving out of the cradle portion.

7. The apparatus of claim 1, further comprising at least one third retainer post that extends from the base portion, wherein:
the second retainer post further comprises:
a first arm portion that extends from the base portion, wherein the first arm portion defines a first cradle portion configured to receive the second elongated article; and
a first projection portion that extends from the first arm portion, the first projection portion configured to prevent the second elongated article from moving out of the first cradle portion; and
the third retainer post further comprises:
a second arm portion that extends from the base portion, wherein the second arm portion defines a second cradle portion configured to receive the second elongated article; and
a second projection portion that extends from the second arm portion, the second projection portion configured to prevent the second elongated article from moving out of the second cradle portion,
wherein the second retainer post and the third retainer post are located on opposite sides of the base portion, and
wherein the first cradle portion and the second cradle portion face away from a center of the base portion.

8. The apparatus of claim 1, wherein the second retainer post defines a saddle portion configured to receive a strap to bind the second elongated article to the second retainer post.

9. The apparatus of claim 8, wherein the second retainer post further comprises a pair of flanges that define a receiver therebetween, the receiver configured to receive a cutter tool for cutting the strap.

10. The apparatus of claim 8, wherein the saddle portion comprises:
a block, the block configured to attach to the second elongated article via the strap, the block defining a strap aperture therethrough, the strap aperture configured to receive the strap therein.

11. The apparatus of claim 1, further comprising:
a cover portion, the cover portion configured to cover at least one of the first retainer posts or at least one of the second retainer posts.

12. The apparatus of claim 11, wherein the cover portion is further configured to cover the first retainer post and the second retainer post.

13. The apparatus of claim 12, further comprising:
a cover support pillar that extends from at least one of the base portion or an underside of the cover portion, the cover support pillar spacing the cover portion apart from the first and second retainer posts, the cover support pillar configured to support the underside of the cover portion.

14. The apparatus of claim 1, further comprising:
at least one third retainer post that extends from the base portion, wherein the second retainer post and the third retainer post are located on opposite sides of the base portion.

15. The apparatus of claim 1, wherein at least one retainer post of the first retainer posts includes a stem that terminates in a cap having a width that is greater than a width of the stem.

16. The apparatus of claim 1,
wherein the base portion includes a center segment that is frangibly attached to a side segment at a breakable portion, the breakable portion connecting the base portion to the center segment, the breakable portion configured to break at a defined snap point along which the breakable portion is configured to break under a predetermined loading condition,
wherein the center segment includes the first retainer posts and the second retainer posts, and
wherein the apparatus further includes at least one third retainer post that extends from the side segment.

17. The apparatus of claim 1, wherein the base portion further comprises:
a connector portion configured to attach the base portion to the support surface, the connector portion comprising at least one of an adhesive fastener or an aperture defined in the base portion that is configured to receive a mechanical fastener.

18. The apparatus of claim 1, wherein the first retainer posts are spaced apart from the second retainer post.

19. The apparatus of claim 1, wherein the first retainer posts define at least two passageways configured to receive a first elongated article therebetween, wherein the apparatus further comprises routing indicia configured to guide a technician to utilize a minimum bend radius when routing the first elongated article between the passageways.

20. The apparatus of claim 1, wherein the second retainer post defines a saddle portion, the saddle portion configured to receive a strap to bind the second elongated article to the second retainer post, the saddle portion further comprising a strap aperture configured to receive the strap, the strap aperture defined through the second retainer post and shaped to guide the strap around the second elongated article.
